(19) United States
(12) Patent Application Publication
(10) Pub. No.: US 2013/0230275 A1
(43) Pub. Date: Sep. 5, 2013

(54) OPTICAL PRINTED CIRCUIT BOARD, APPARATUS AND METHOD FOR MANUFACTURING SAME

(71) Applicant: Bing-Heng LEE, Tu-Cheng (TW)

(72) Inventor: Bing-Heng LEE, Tu-Cheng (TW)

(73) Assignee: HON HAI PRECISION INDUSTRY CO., LTD., Tu-Cheng (TW)

(21) Appl. No.: 13/584,757

(22) Filed: Aug. 13, 2012

(30) Foreign Application Priority Data
Mar. 2, 2012 (TW) 101107002

(51) Int. Cl. G02B 6/12; B05D 5/06; B05C 11/00; B05C 1/00

(52) U.S. Cl. 385/14; 118/58; 427/162

(57) ABSTRACT

An optical printed circuit board (OPCB) includes a rigid substrate, a first cladding layer, a core layer, and a second cladding layer. The first cladding layer is formed on the substrate, the core layer is formed on the first cladding layer, and the second cladding layer is formed on the core layer. The core layer defines optical waveguide patterns. The refractive rate of the core layer is greater than the refractive rate of the first cladding layer and the refractive rate of the second cladding layer.

### BACKGROUND

1. Technical Field

The present disclosure relates to an optical printed circuit board (OPCB), an apparatus and a method for manufacturing the OPCB.

2. Description of Related Art

OPCBs include core layers for transmitting optical signals. The core layers define optical waveguide patterns. In related art, the optical waveguide patterns are formed using yellow light photolithograph method. However, the yellow light photolithograph method needs much time, which will reduce the manufacturing efficiency of the OPCBs.

Therefore, it is desirable to provide an OPCB, an apparatus and a method for manufacturing the OPCB that can overcome the above-mentioned limitations.

### BRIEF DESCRIPTION OF THE DRAWINGS

Many aspects of the embodiments should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an OPCB, according to a first exemplary embodiment.

FIG. 2 is schematic view of an apparatus for manufacturing the OPCB of FIG. 1, according to a second exemplary embodiment.

FIG. 3 is a flow chart of a method for manufacturing the OPCB of FIG. 1, according to a third exemplary embodiment.

### DETAILED DESCRIPTION

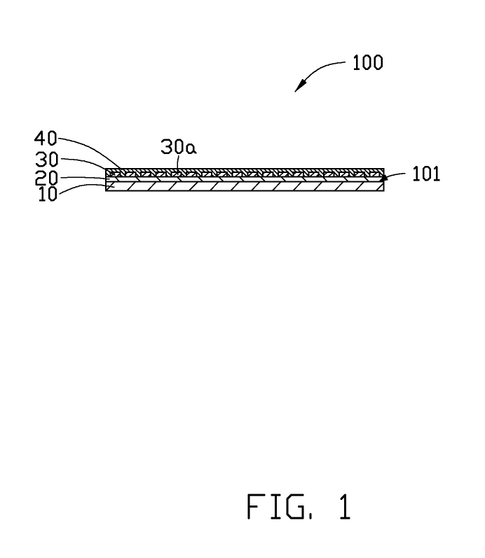

FIG. 1 illustrates an optical printed circuit board (OPCB) 100 in accordance with a first exemplary embodiment. The OPCB 100 includes a rigid substrate 10 having a loading surface 101, a first cladding layer 20 formed on the loading surface 101 of the substrate 10, a core layer 30 formed on the first cladding layer 20, and a second cladding layer 40 formed on the core layer 30. The core layer 30 defines an optical waveguide pattern 30a.

The substrate 10 is substantially cuboid and has a circuit layer (not shown). The circuit layer may be made of metal material or conductive compound. The metal material may be gold, silver, or copper. The conductive compound may be indium tin oxide (ITO).

The refractive index of the core layer 30 is greater than the refractive index of the first cladding layer 20 and the refractive index of the second cladding layer 40. The core layer 30 is made of a high refractive index material, such as the following materials with light-sensitive groups: polyacrylate, polysiloxane, polyimide, polycarbonate, fluorinated polymer, or mixture of the above materials.

The first cladding layer 20 and the second cladding layer 40 are made of a low refractive index material, such as the following materials without light-sensitive groups: polyacrylate, polysiloxane, polyimide, polycarbonate, fluorinated polymer, or mixture of the above materials.

In this embodiment, the material of the second cladding layer 40 is the same as the material of the first cladding layer 20. In other embodiments, the material of the second cladding layer 40 can be different from the material of the first cladding layer 20.

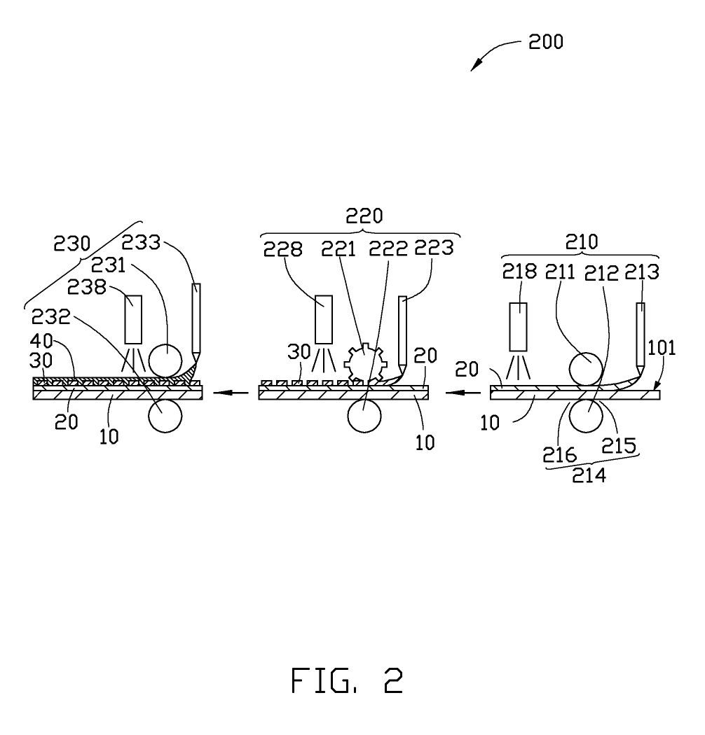

Referring to FIG. 2, an apparatus for manufacturing the OPCB 200, according to a second exemplary embodiment, includes a first pressing device 210, a second pressing device 220, and a third pressing device 230.

The first pressing device 210 includes a first pressing roller 211, a first auxiliary roller 212, a first feeder 213, and a first drying element 218. The first pressing roller 211 has a smooth first circumferential surface. The first pressing roller 211 is above the first auxiliary roller 212, and is spaced at a predetermined distance from the first auxiliary roller 212, and thus forms a molding channel 214 therebetween.

The molding channel 214 includes an inlet 215 and an outlet 216. The first feeder 213, the first drying element 218, and the first pressing roller 211 are positioned on a first side of the molding channel 214. The first auxiliary roller 212 is positioned on a second side of the molding channel 214 opposite to the first side. The first pressing roller 211 is positioned between the first feeder 213 and the first drying element 218. The first feeder 213 is used for providing a first cladding layer forming a solvent. The first pressing roller 211 and the first auxiliary roller 212 are rotated in opposite directions, and press the first cladding layer forming a solvent on the loading surface 101 to form a first cladding solvent layer. The first pressing roller 211 and the first auxiliary roller 212 also cooperatively transfer the substrate 10 from the inlet 215 to the outlet 216. The drying element 218 is used for solidifying the first cladding solvent layer to obtain the first cladding layer 20. In this embodiment, the first pressing roller 211 is rotated clockwise, and the first auxiliary roller 212 is rotated counterclockwise.

The second pressing device 220 is used for forming a core layer 30 with optical waveguide patterns on the first cladding layer 20. The second pressing device 220 is different from the first pressing device 210 and includes a second pressing roller 221, a second auxiliary roller 222, a second feeder 223, and a second drying element 228 in that order as the substrate 10 moves along. The second feeder 223 is used for providing a core layer forming solvent. The substrate 10 with the first cladding layer 20 passes through a channel between the second pressing roller 221 and the second auxiliary roller 222, and thus the core layer forming solvent is pressed on the first cladding layer 20 to obtain a core layer solvent layer. The second drying element 228 is used for drying the core layer solvent layer to obtain the core layer 30. The difference between the first pressing device 210 and the second pressing device 220 is that the second pressing roller 221 has a second circumferential surface with impression patterns coupled with the optical waveguide patterns.

The third pressing device 230 is used for forming a second cladding layer 40 on the core layer 30. The structure of the third pressing device 230 is the same as the structure of the first pressing device 210 and includes a third pressing roller 231, a third auxiliary roller 232, a third feeder 233, and a third drying element 238 in that order as the substrate 10 moves along. The third pressing roller 231 has a smooth third circumferential surface. The third feeder 233 is used for providing a second cladding forming solvent. The substrate 10 with the first cladding layer 20 and the core layer 30 passes through a channel between the third pressing roller 231 and the third auxiliary roller 232, and thus the second cladding layer forming solvent is pressed on the core layer 30 to obtain a second cladding solvent layer. The third drying element 238 is used for solidifying the second cladding solvent layer to form the second cladding layer 40.

The direction of movement of the substrate 10 is substantially the same as the lengthwise direction of the substrate 10. The distance between the first pressing roller 211 and the second pressing roller 221 and the distance between the second pressing roller 221 and the third pressing roller 231 are both less than the length of the substrate 10. The first pressing roller 211, the second pressing roller 221, and the third pressing roller 231 are at a same height with respect to a horizontal surface, and the first auxiliary roller 212, the second auxiliary roller 222, and the third auxiliary roller 232 are at the same height with respect to the same horizontal surface. Therefore, the substrate 10 can move from the first pressing device 210 to the second pressing device 220, and then automatically enter the third pressing device 230. In this embodiment, the distance between the first pressing roller 211 and the second pressing roller 221 is substantially equal to the distance between the second pressing roller 221 and the third pressing roller 231.

In this embodiment, the first drying element 218, the second drying element 228, and the third drying element 238 are ultraviolet (UV) sources.

Each of the first auxiliary roller 212, the second auxiliary roller 222, and the third auxiliary roller 232 has a smooth outer circumferential surface.

The roller pressing apparatus 200 also can be used for manufacturing other elements. The outer circumferential surfaces of the first to third auxiliary rollers 212, 222, 232 and the first to third pressing rollers 211, 221, 231 can be designed or redesigned according to a user's requirement.

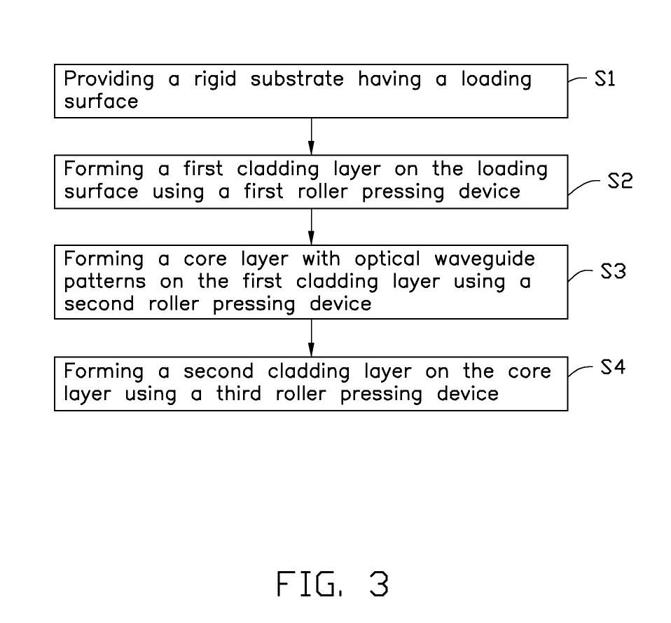

Referring to FIG. 3, a method for manufacturing the OPCB 100 using the apparatus 200, according to a third exemplary embodiment, is shown. The method includes the following steps.

In step S1: the rigid substrate 10 having a loading surface 101 is provided, and the loading surface 101 is cleaned.

In step S2, the first cladding layer 210 is formed on the substrate 10 using the first pressing device 210. In particular, the substrate 10 is positioned on the inlet 215, and the loading surface 101 faces the first feeder 213. The first feeder 213 provides the first cladding layer forming a solvent to the loading surface 101, the first pressing roller 211 and the first auxiliary roller 212 rotate to press the first cladding layer forming a solvent on the loading surface 101 to form a first cladding solvent layer, then the first drying device 218 solidifies the first cladding solvent layer to obtain the first cladding layer 20.

In step S3, the substrate 10 with the first cladding layer 20 directly enters the second roller pressing device 220, and the core layer 30 with optical waveguide patterns is formed on the first cladding layer 20 using the second roller pressing device 220. In particular, the second feeder 223 provides a core layer forming solvent to the first cladding layer 20. The second pressing roller 221 and the second auxiliary roller 222 cooperatively press the core layer forming solvent on the first cladding layer 20 to obtain the core layer solvent layer 30. The second drying element 228 solidifies the core solvent layer to obtain the core layer 30 with optical waveguide patterns.

In step S4, the substrate 10 with the first cladding layer 20 and the core layer 30 directly enters the third roller pressing device 230, and the second cladding layer 40 is formed on the core layer 30 using the third roller pressing device 230. In particular, the third feeder 238 provides a second cladding forming a solvent to the core layer 30. The third pressing roller 231 and the second auxiliary roller 232 cooperate to press the second cladding forming solvent on the core layer 30 to obtain the second cladding solvent layer. The third drying element 238 solidifies the second cladding solvent layer to obtain the second cladding layer 40.

By employing the first to third roller pressing devices 210, 220, 230, the optical waveguide patterns can be directly formed on the core layer 30, and thus the manufacturing efficiency is greatly improved. At the same time, the first to third roller pressing devices 210, 220, 230 will not produce chemical waste, and thus represent no threat to the environment.

It will be understood that the above particular embodiments and methods are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical printed circuit board (OPCB), comprising:
a rigid substrate having a loading surface,
a first cladding layer on the loading surface,
a core layer with optical waveguide patterns on the first cladding layer, and
a second cladding layer on the core layer;
wherein a refractive rate of the core layer is greater than a refractive rate of the first cladding layer and a refractive rate of the second cladding layer.

2. The OPCB of claim 1, wherein a material of the first cladding layer is the same as a material of the second cladding layer.

3. An apparatus for manufacturing an OPCB, comprising:
a first roller pressing device comprising:
a first feeder configure for providing a first cladding forming solvent;
a first pressing roller having a smooth first circumferential surface;
a first auxiliary roller separating from the first pressing roller and configured for cooperating with the first pressing roller to press the first cladding forming solvent on a substrate to obtain a first cladding solvent layer; and
a first drying element configure for solidifying the first cladding solvent layer to obtain a first cladding layer;
a second roller pressing device comprising:
a second feeder configure for providing a core layer forming solvent;
a second pressing roller having a second circumferential surface with impression patterns;
a second auxiliary roller separating from the second pressing roller and configured for cooperating with the second pressing roller to press the core layer forming solvent on the first cladding layer to obtain a core solvent layer; and
a second drying element configure for solidifying the core solvent layer to obtain a core layer; and
a third roller pressing device comprising:
a third feeder configure for providing a second cladding forming solvent;
a third pressing roller having a smooth third circumferential surface;
a third auxiliary roller separating from the third pressing roller and cooperating with the third pressing roller to press the second cladding forming solvent on the core layer to obtain a second cladding solvent layer; and
a third drying element configure for solidifying the second cladding solvent layer to obtain a second cladding layer.

4. The apparatus for manufacturing the OPCB of claim 3, wherein each of the first auxiliary roller, the second auxiliary roller, and the third auxiliary roller has a smooth outer circumferential surface.

5. The apparatus for manufacturing the OPCB of claim 3, wherein a moving direction of the substrate is substantially the same as a length direction of the substrate, a distance between the first pressing roller and the second pressing roller and a distance between the second pressing roller and the third pressing roller are less than a length of the substrate.

6. The apparatus for manufacturing OPCB of claim 3, wherein the first pressing roller, the second pressing roller, and the third pressing roller are on a same height with respect to a same horizontal surface, and the first auxiliary roller, the second auxiliary roller, and the third auxiliary roller are on a same height with respect to the same horizontal surface.

7. A method for manufacturing an OPCB, comprising:
providing a rigid substrate having a loading surface;
providing a first cladding forming solvent to the loading surface using a first feeder;
pressing the first cladding forming solvent on the substrate using a first pressing roller and a first auxiliary roller to form a first cladding solvent layer, the first pressing roller having a smooth first circumferential surface;
solidifying the first cladding solvent layer using a first drying element to form a first cladding layer on the loading surface;
providing a core layer forming solvent on the first cladding layer using a second feeder;
pressing the core layer forming solvent on the first cladding layer using a second pressing roller and a second auxiliary roller to obtain a core layer solvent layer with an optical waveguide pattern, the second pressing roller having a second circumferential surface with impression patterns corresponding to the optical waveguide pattern;
solidifying the core layer solvent layer using a second drying element to form a core layer on the first cladding layer;
providing a second cladding forming solvent on the core layer using a third feeder;
pressing the second cladding forming solvent on the core layer using a third pressing roller and a third auxiliary roller to form a second cladding solvent layer, the third pressing roller having a smooth third circumferential surface; and
solidifying the second cladding solvent layer using a third drying element to obtain a second cladding layer;
wherein a refractive rate of the core layer is greater than a refractive rate of the first cladding layer and a refractive rate of the second cladding layer.

8. The method for manufacturing the OPCB of claim 7, wherein a moving direction of the substrate is substantially the same as a length direction of the substrate, a distance of the first pressing roller and the second pressing roller and a distance between the second pressing roller and the third pressing roller are less than a length of the substrate, and thus the substrate automatically moves from the first pressing roller to the second pressing roller, then automatically reaches the third pressing roller.

9. The method for manufacturing the OPCB of claim 7, wherein each of the first auxiliary roller, the second auxiliary roller, and the third auxiliary roller has a smooth outer circumferential surface.
